(19) United States
(12) Patent Application Publication
(10) Pub. No.: US 2010/0169153 A1
(43) Pub. Date: Jul. 1, 2010

(54) User-Adaptive Recommended Mobile Content

(75) Inventors: Jaime Hwacinski, Sammamish, WA (US); Alexandra K. Heron, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/344,329

(22) Filed: Dec. 26, 2008

(51) Int. Cl. G06Q 30/00; G06Q 10/00

(52) U.S. Cl. 705/10; 705/14.58

(57) ABSTRACT

Techniques are described to provide user-adaptive recommended mobile content. In an example implementation, one or more user-specific parameters are detected on a mobile device. Examples of user-specific parameters may include user behavior on the mobile device, the location of the user and/or mobile device, the behavior of a user's associate as part of a social network, and so on. The user-specific parameters are used to identify recommended content that is relevant to the user-specific parameters, and the user is notified of the recommended content. The recommended content may be accessed via the mobile device.

### BACKGROUND

A vast variety of content is available to users of mobile devices. Sorting through this vast variety of content to find content of interest to a particular user may be a formidable task. A user of a mobile device may expend a great deal of time attempting to locate content relevant to the user's interest, thus decreasing the quality of the mobile device user experience. Also, portals for accessing content (e.g., a web browser) typically do not consider user-specific parameters (e.g., user preferences, the user's location, and so on) in presenting content to a user. This often results in irrelevant content being presented to a user, which also decreases the quality of the user's experience with the mobile device.

### SUMMARY

Techniques are described to provide user-adaptive recommended mobile content. In an implementation, one or more user-specific parameters are detected on a mobile device. Examples of user-specific parameters may include user behavior on the mobile device, the location of the user and/or mobile device, the behavior of a user's associate as part of a social network, and so on. The user-specific parameters are used to identify recommended content that is relevant to the user-specific parameters, and the user is notified of the recommended content. The recommended content may be accessed via the mobile device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to provide user-adaptive recommended mobile content techniques.

FIG. 2 is a flow diagram depicting a procedure in an example implementation in which user-specific parameters are used to recommend content to a user of a mobile device.

FIG. 3 is a flow diagram depicting a procedure in an example implementation in which a user is notified of recommended content that is identified based on user behavior data.

FIG. 4 is a flow diagram depicting a procedure in an example implementation in which user behavior data is used to identify recommended content.

FIG. 5 is a flow diagram depicting a procedure in an example implementation in which location information is used to identify recommended content.

FIG. 6 is a flow diagram depicting a procedure in an example implementation in which social network data is used to identify recommended content for a user of a mobile device.

FIG. 7 is an illustration of an example user interface that is configured to notify a user of recommended content.

### DETAILED DESCRIPTION

Overview

User-specific parameters tracked on a mobile device may be utilized to locate recommended content for a user (e.g., content that is relevant to the user) and notify a user of the recommended content. In an example scenario, a user frequently uses a mobile device to navigate to one or more websites that display baseball scores. Based on this web navigation behavior, the user may be provided with links to baseball-related websites that the user has not previously viewed. The links may be displayed in a window as part of the user's homepage and/or other interface that the user is viewing. An advertisement for a baseball-related vendor or business may also be retrieved and provided to the user. For example, the advertisement may indicate that tickets are available for a baseball game occurring on a particular day and near the user's current location. The advertisement may include a link that, if selected, enables the user to buy tickets to the baseball game and/or share information about the game (e.g., the ability to buy the tickets) with one or more friends.

In another example scenario, a user in Seattle sends an email from the user's mobile device to a friend, and the email includes the terms “Etta's” and “seafood”. These terms are detected from the email, and one or more advertisements are retrieved that relate to seafood restaurants that are in the Seattle area. The advertisements may be provided to the mobile device and viewed by the user, e.g., as part of an email-related interface on the user's mobile device, as part of a web browser interface, and so on.

In addition to websites and advertisements, other examples of recommended content may include multimedia content (e.g., video and/or audio), a web log (“blog”), and so on. Also, a wide variety of user-specific parameters may be considered in identifying recommended content, such as user behavior on a mobile device (e.g., websites that the user navigates to, content of emails and/or instant messages that a user sends and/or receives, entities associated with phone numbers that the user has dialed, search terms provided by a user, and so on), the location of the user (e.g., the geographic location), content shared with the user via a social network, the behavior of one or more of the user's associates in a social network (e.g., a user's friend that is part of the user's social network), and so on.

User-specific parameters may also be time-relevant, e.g., relevant to a particular time-of-day. For example, if a user often views a particular web page in the morning, content may be recommended to the user during the morning that is related to the particular web page. As another example, if a user is traveling, time-relevant content may be recommended that correlates to the location and the time-of-day. For example, during the morning, recommended content may include nearby restaurants that serve breakfast.

Thus, a variety of user-specific parameters may be considered in providing recommended content to a user, such as user preferences and/or other information that the user has expressly indicated. In another example scenario, a user has provided to a mobile device a transportation route that the user takes to travel to and from work. For example, the user indicates the particular streets that the user travels on during the user's commute to and/or from work. In anticipation of a particular morning's commute to work, the mobile device detects that the traffic on the transportation route is experiencing long delays. The mobile device may then notify the user of the traffic delays, such as via a graphic and/or audio notification on the mobile device. The mobile device may also provide information about activities that the user may engage in while waiting for the traffic to clear, such as a coffee promotion available at a nearby coffee shop.

While aspects of recommended mobile content techniques are described herein in relation to content provided by an external content service, it is contemplated that the techniques may be employed to retrieve recommended content in a variety of settings. For example, an application executing on a mobile device may collect user-specific parameters and retrieve recommended content from one or more content sources without utilizing a content service that is external to the mobile device. A variety of other examples are also contemplated.

In the following discussion, an example environment is first described that is operable to employ user-adaptive recommended mobile content techniques. Next, example procedures are then described which may be employed by the example environment, as well as in other environments. Finally, an example user interface is described which may display and/or otherwise provide a notification to a user of recommended content.

Example Environment

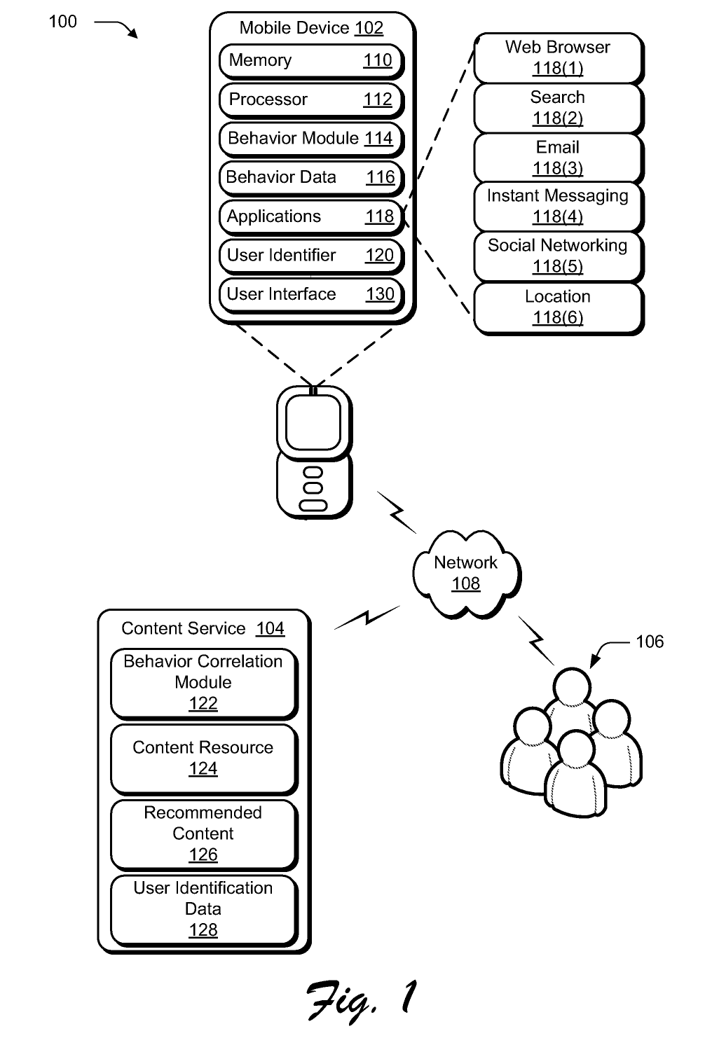

FIG. 1 is an illustration of an environment 100 in an example implementation that is operable to notify a mobile device user of recommended content that is available for a mobile device. The illustrated environment 100 includes a mobile device 102, a content service 104, and a social network 106 that are communicatively coupled, one to another, over a network 108. For purposes of the following discussion, a referenced component, such as content service 104, may refer to one or more entities, and therefore by convention reference may be made to a single entity (e.g., the content service 104) or multiple entities (e.g., the content services 104, the plurality of content services 104, and so on) using the same reference number.

The mobile device 102 may be configured in a variety of ways for enabling a user to access recommended content. For example, the mobile device 102 may be configured as a personal digital assistant (“PDA”), a smart phone, a notebook computer, and so on. The mobile device 102 is illustrated as including a memory 110 and a processor 112. The memory 110 may be configured to store modules and/or other logic that may be executed by the processor 112 to perform one or more aspects of the techniques discussed herein.

To assist in providing a user of the mobile device 102 with recommended content, the mobile device 102 includes a behavior module 114 that is representative of functionality to detect user behavior associated with a user of the mobile device 102, such as user behavior on the mobile device, a location of the user and/or the mobile device 102, and/or the behavior of one or more user associates as part of a social network. The user behavior detected by the behavior module 114 may then be stored for later use, which is represented in FIG. 1 by behavior data 116. For example, the behavior data 116 may be used to locate recommended content that correlates to the user behavior detected on the mobile device.

In an example implementation, the behavior module 114 may accumulate behavior data by detecting user interaction with one or more applications 118. The applications 118 may be configured in a variety of ways to provide a variety of functionality to the mobile device 102. By way of example, the applications 118 may include a web browser 118(1), a search application 118(2), an email application 118(3), a messaging application 118(4) (e.g., instant messaging, short messaging service (SMS), multimedia messaging service (MMS), and so on), a social networking application 118(5), and a location application 118(6). It should be readily apparent that the applications 118 may include a variety of different types and instances of applications. Additionally and/or alternatively, the applications 118 may be configured for access via platform-independent protocols and standards to exchange data over the network 108. The applications 118, for instance, may be provided via an Internet-hosted module that is accessed via standardized network protocols, such as a simple object access protocol (SOAP) over hypertext transfer protocol (HTTP), extensible markup language (XML), and so on.

To retrieve recommended content, the behavior data 116 may be provided to the content service 104 along with a user identifier 120. The user identifier 120 may provide a way of identifying the mobile device 102 and/or a user of the mobile device, and may be utilized to track one or more batches of recommended content that are gathered by the content service. In an implementation, the user identifier 120 may be transmitted to an external service (e.g., the content service 104) and used to retrieve recommended content from the external service. The user identifier 120 may be configured as one or more of a variety of different identifiers, such as a GUID, a MAC address, an authentication identifier specified by the user of the mobile device (e.g., a username and/or password), and so on.

The content service 104 may be configured in a variety of ways for identifying recommended content for a user of a mobile device, e.g., mobile device 102. The content service 104 may include a server and/or group of servers, a service hosted on a PC, a web computing service, and so on. In an example implementation, the content service 104 may receive the behavior data 116 and, as part of the content service, a behavior correlation module 122 may process the behavior data to identify recommended content that correlates to the user behavior data. A variety of different correlation factors may be considered, such as keyword matching, web sites visited, instant messaging logs, phone call history, geographic location, email content, and so on. As one example source of recommended content, a content resource 124 may be configured as a repository of searchable content and/or as a tool for accessing one or more external content providers. Content that is located that correlates to user behavior data (e.g., recommended content) may be stored as recommended content 126, which may be configured to store recommended content for one or more users and catalogue the recommended content for one or more users. For example, recommended content may be marked with a particular identifier (e.g., the user identifier 120) for retrieval for a user and/or mobile device.

To assist in identifying particular users and/or devices, and to track recommended content that has been gathered, user identification data 128 is included with the content service 104. In an example implementation, the user identification data may include user identifiers (e.g., the user identifier 120), one or more of which may be used to connect a particular user with recommended content for the user. For example, the content service 104 may receive user identifier 120 from the mobile device 102 and may store the user identifier as part of user identification data 128. The user identifier may be retrieved and used to link recommended content to the mobile device 102 and/or a user of the mobile device.

Recommended content that has been identified and gathered by the content service 104 may be transmitted to the mobile device 102. The mobile device 102 may present the recommended content to a user via the mobile device, for example, by including the recommended content with a user interface 130. The user interface 130 may be configured to notify a user of recommended content on the mobile device 102, such as by providing a notification of the recommended content for display on a display screen of the mobile device. The user interface 130 may be associated with one or more of the applications 118 and/or accessible to one or more of the applications.

User-specific parameters may also be collected from the social network 106, which may include individuals and/or groups of individuals that communicate with a user of mobile device 102. In some implementations, these individuals and/or groups of individuals may be considered “associates” of the user of mobile device 102, since they associate with the user via the social network 106. An associate may communicate with the user of mobile device 102 via one or more of a variety of different ways, including email, instant messaging, a social networking service, and so on. As discussed in more detail below, the behavior of one or more social network associates may be used to identify recommended content for a user of a mobile device.

Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be configured to include multiple networks.

Generally, any of the functions described herein may be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., processor 112 on mobile device 102). The program code may be stored in one or more computer-readable memory devices, such as memory 110 on mobile device 102. The features of recommended mobile content techniques described below are platform-independent, meaning that the techniques may be implemented on a variety of commercial computing platforms having a variety of processors.

Example Procedures

The following discussion describes recommended mobile content techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference may be made to the environment 100 of FIG. 1.

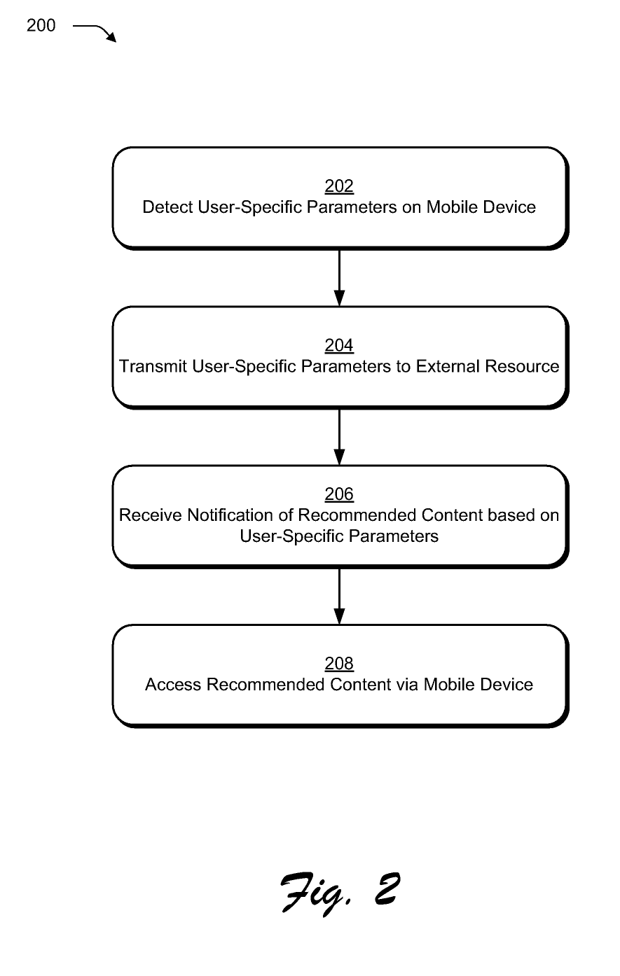

FIG. 2 depicts a procedure 200 in an example implementation in which user-specific parameters are used to recommend content to a user of a mobile device. One or more user-specific parameters are detected on a mobile device (block 202). Examples of user-specific parameters are discussed above. The user-specific parameters are transmitted to an external resource to be used to locate recommended content (block 204). One example of an external resource is content service 104. A notification of recommended content is received based at least in part on the user-specific parameters (block 206). As discussed above, the notification may include one or more features that enable a user to access the recommended content (e.g., a hyperlink), and/or one or more instances of recommended content (e.g., a web page). In an example implementation, when the notification is received, the notification may be automatically populated into the user's homepage on the mobile device (e.g., in a web browser interface on the device). One or more instances of recommended content are accessed via the mobile device (block 208). For example, a user of the mobile device may select a hyperlink included in the notification to navigate to a web page or other resource that hosts one or more instances of recommended content.

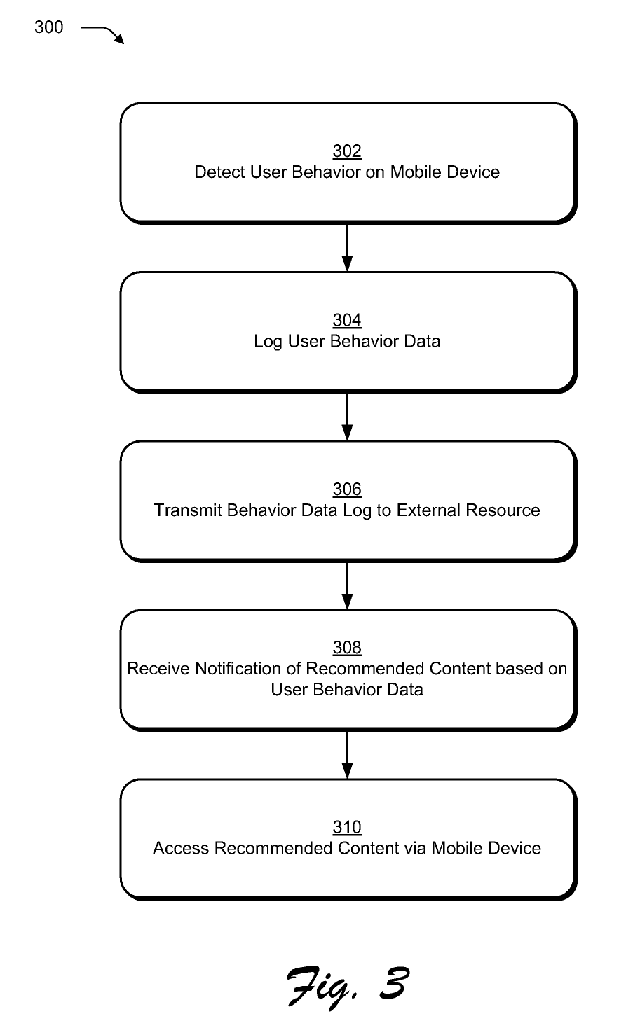

FIG. 3 depicts a procedure 300 in an example implementation in which a user is notified of recommended content that is identified based on user behavior data. User behavior is detected on a mobile device (block 302). For example, behavior module 114 may automatically detect one or more aspects of user behavior on a mobile device. For purposes of this example, a user conducts several searches related to gardening and navigates to several gardening-related websites. The gardening-related search terms (e.g., “rhododendrons” and “pruning”) and the websites (e.g., “www.rhododentron.org) are detected as user behavior. The user behavior is logged as user behavior data (block 304). For instance, behavior that is detected by behavior module 114 may be logged as part of behavior data 118.

The behavior data log is transmitted to an external resource (block 306). Continuing with the current example, the gardening-related behavior data may be transmitted to content service 104. A notification of recommended content is received based at least in part on the user behavior data (block 308). In the current example, several links to gardening-related websites may be transmitted to the mobile device. One or more instances of recommended content are accessed via the mobile device (block 310). For example, the user may select one of the gardening-related web links, and in response, a web browser running on the mobile device browses to a website identified by the link.

Alternatively and/or additionally to providing a notification of recommended content, instances of the recommended content may be provided to the mobile device, such as a web page, streaming video and/or audio, and so on. In the current example, a window within the user's web browser interface may display a streaming video that includes a commercial for a sale at a plant nursery that is local to the location of the mobile device.

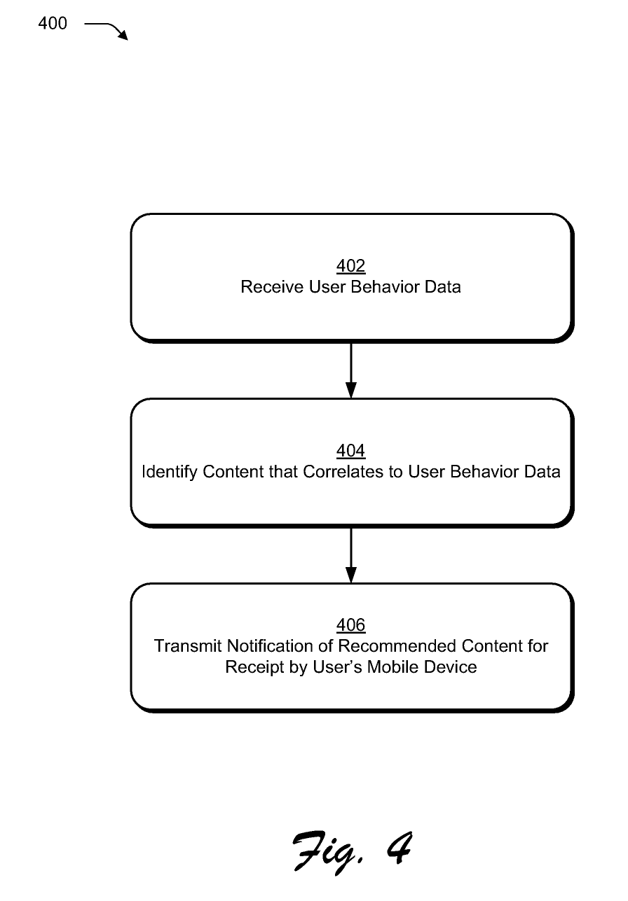

FIG. 4 depicts a procedure 400 in an example implementation in which user behavior data is used to identify recommended content. User behavior data is received (block 402). Using the example scenario discussed above in FIG. 3, the user behavior data includes the gardening-related search terms and gardening websites that the user has navigated to. For example, the behavior data 118 may include the gardening-related behavior data and may be received at the content service 104. Content is identified that correlates to the user behavior data (block 404). In the current example, the links to gardening-related websites and/or an advertisement for a gardening-related vendor are identified. In an example implementation, the behavior correlation module 122 processes the behavior data and identifies content (e.g., from content resource 124) that may be recommended to a user of a mobile device. In identifying recommended content, content that a user has previously consumed (e.g., websites that the user has viewed) may be excluded from the recommended content, thus the recommended content may include content that the user has not previously consumed. For example, a user's browsing history may be used to filter previously-consumed content out of the recommended content so that the user is not notified of this content. A notification of the recommended content is transmitted for receipt by a user's mobile device (block 406). Continuing with the gardening-related example, the notification may include the links to the gardening-related websites and/or an instance of gardening-related content, such as the previously-mentioned streaming video.

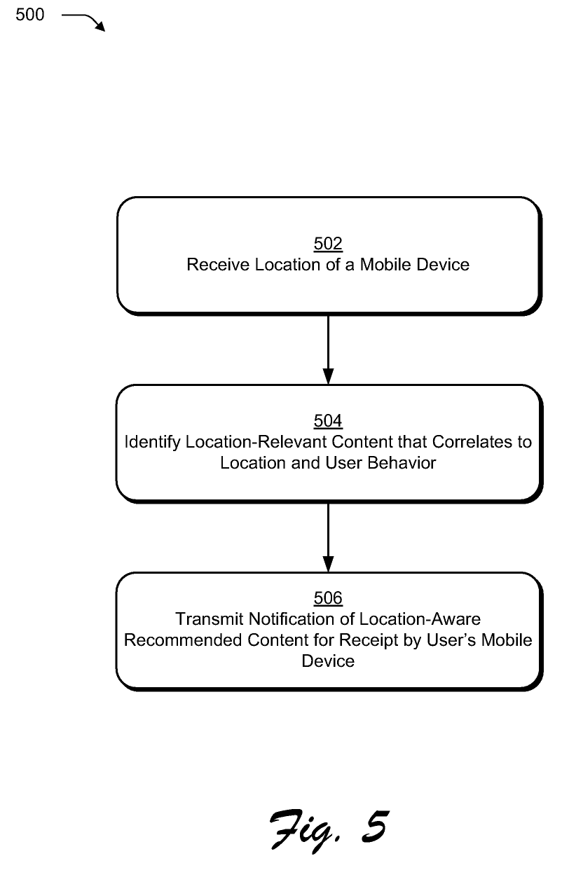

FIG. 5 depicts a procedure 500 in an example implementation in which location information is used to identify recommended content. A location of a mobile device is received (block 502). In an example implementation, the location application 118(6) determines the location of the mobile device via one or more suitable techniques and transmits the location to the content service 104. Examples of suitable location-determining techniques include global positioning system (GPS), cell phone tower triangulation, and so on. In an example implementation, a user may input location information to the mobile device (e.g., a city, a state, GPS coordinates, and so on). For purposes of this example, a user that is using the mobile device is located in the Ballard district of Seattle, Wash. An indication of this location is received at the content service.

Location-relevant content is identified that correlates to user behavior data and the location of the mobile device (block 504). For example, behavior correlation module 122 may process behavior data and location data to identify recommended content that correlates to both. Continuing the most recent example, imagine that the user behavior data on the mobile device indicates that the user often selects sports-related content. The recommended content may include information (e.g., an advertisement) about a restaurant where sports events are televised and that is within a certain proximity (e.g., 1 mile) of the Ballard district. Thus, the techniques discussed herein may be utilized to locate businesses, services, and/or other entities that are within a certain proximity of a mobile device and that correlate to user behavior on the mobile device (e.g., one or more user preferences). The techniques may utilize a pre-specified proximity, such as a default distance setting, and/or a user may specify a proximity setting to be used in identifying location-relevant recommended content. A notification of the location-relevant recommended content is transmitted for receipt by the mobile device (block 506). In the current example, the notification may include an advertisement and/or other information about a sports tavern in the Ballard district.

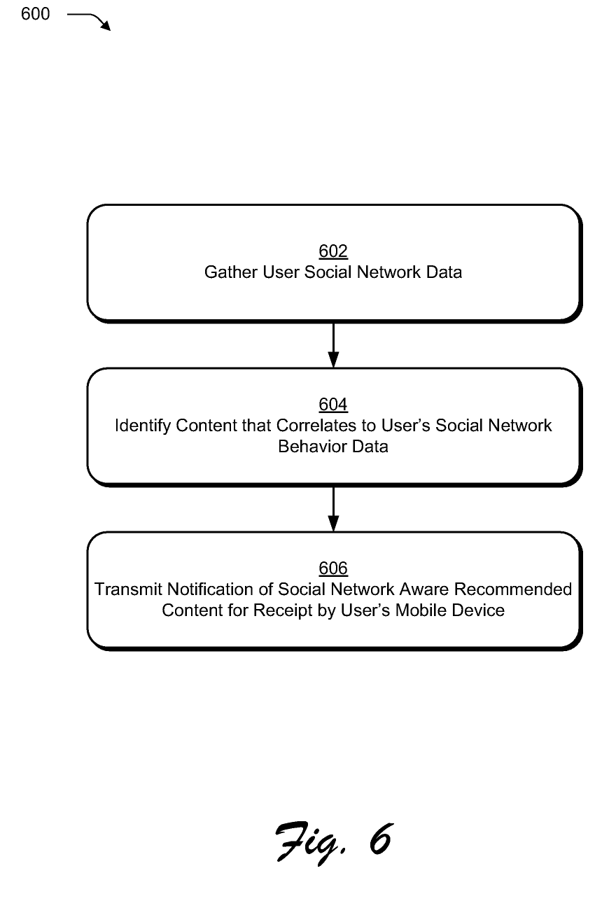

FIG. 6 depicts a procedure 600 in an example implementation in which social network data is used to identify recommended content for a user of a mobile device. Social network data is gathered (block 602). For example, the behavior of one or more of a user's associates in a social network may be detected. Behavior of a user's associate in a social network may include websites that the associate has visited, the content of emails and/or instant messages that the associate has sent and received, searches that the associate has conducted, and so on. As an example, a friend that is part of the user's social network shares several links to mountain biking websites with the user. These shared links are detected (e.g., by the behavior module 114) and logged as social network data.

Recommended content is identified that correlates to the social network data (block 604). In the most recent example, the content service 104 may locate recommended content which correlates to mountain biking. A notification of social network-relevant recommended content is transmitted for receipt by the mobile device (block 606). Continuing the current example, several links for mountain biking websites may be transmitted to the user's mobile device, along with streaming audio that describes a sale at a bike shop local to the user's place of residence.

The social network data may also be used to identify recommended activities that a user may engage in with others, e.g., a family member, a friend, and/or a user's associate as part of a social network. A recommended activity may also be correlated with a user's calendar, such as a calendar item indicated on the user's mobile device. In an example implementation scenario, social network data indicates that a user's spouse is particularly interested in tropical plants. Based on this information, the user's mobile device receives information that a tropical plant show is occurring on an upcoming date and time and at a venue local to the user's residence. The mobile device checks the user's calendar on the mobile device to determine if any events are already scheduled for the particular date and time of the tropical plant show. For example, the behavior module 114 may query a calendar application resident on the mobile device 102 to determine if any such events are scheduled. The user is then notified of the tropical plant show and, if the user's calendar indicates that the user has an open time slot to attend the show, the user is notified as such. If the user does not have an open time slot, the user may be asked (e.g., via a query presented on the mobile device) if the user wants to cancel or reschedule a conflicting calendar event so that the user may attend the tropical plant show.

Other persons that are a part of the user's social network may also be notified of a recommended activity. In the current example, the user's spouse is notified of the tropical plant show. In response to the notification, the user's spouse indicates whether or not the spouse is interested in attending the show. This indication may be provided to the user. If the user's spouse indicates an interest in attending the tropical plant show, the user's calendar may be automatically updated to create an event associated with the show.

One or more events on a user's calendar may also be used as a basis for identifying a recommended activity. In an example implementation scenario, a user's calendar on the user's mobile device has an event labeled “Dinner with Pia”. Based on this information, information is retrieved that includes information about restaurants local to the user that may be of interest to the user and/or one or more of the user's social network associates, such as Pia. For example, a local restaurant may have a particular dinner special that overlaps with the date and time of the user's dinner event. The user is notified of the dinner special, and in this example, Pia may also be notified on the dinner special. Thus, the techniques discussed herein may be implemented to provide recommended content, such as a recommended activity, that corresponds to a wide range of user-specific and social-network-based interactions and information.

Example User Interface

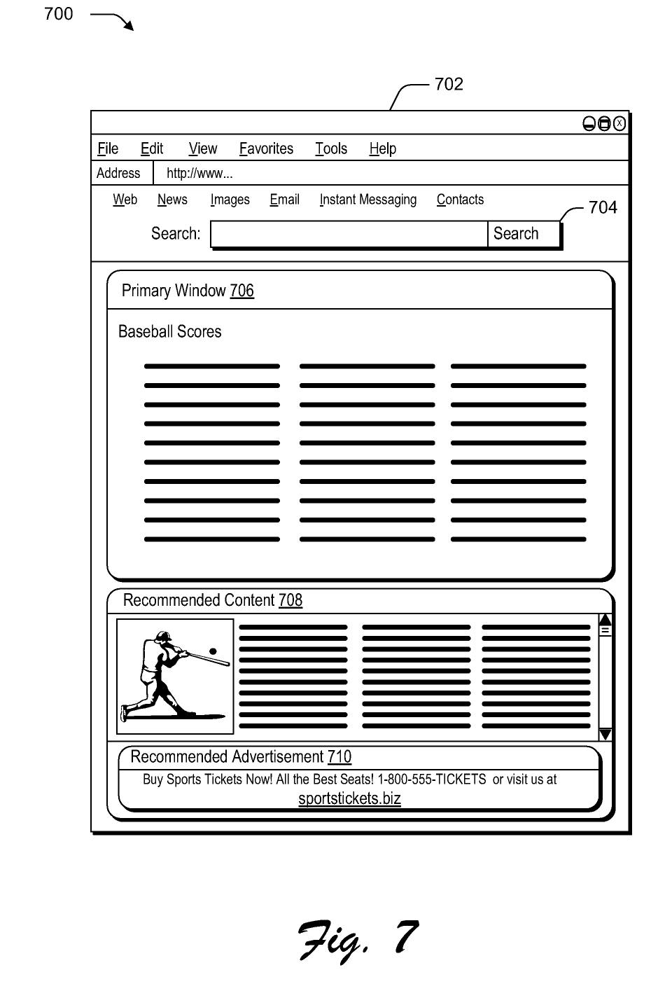

FIG. 7 illustrates at 700 an example implementation of a user interface 702 that may be displayed on a mobile device and may be configured to notify a user of the mobile device of recommended content. The user interface 702 illustrates one example of user interface 130, discussed above in the discussion of environment 100. The user interface 702 may be associated with one or more of a variety of different applications and/or utilities, such as the web browser 118(1). In an example implementation, the user interface 702 may include an example of a user's homepage that is displayed automatically when a user opens an application, such as a web browser. User interface 702 includes a search bar 704 which is configured to enable a user to conduct searches based on one or more search terms. Search bar 704 may be associated any suitable application or utility, such as search application 118(2), and may enable a user to search a variety of different information sources, such as the Internet, mobile device 102, and so on. In an example implementation, search terms that are entered via search bar 704 may be detected and utilized to locate recommended content.

The user interface 702 also includes a primary window 706 and a recommended content window 708. The primary window 706 is configured to display content that a user selects, such as the user's homepage and/or a web page that the user navigates to. The recommended content window 708 is configured to include a notification of recommended content. As mentioned above, the notification may include selectable features (e.g., a hyperlink) that enable a user to navigate to recommended content. The notification may also include one or more instances of recommended content, such as, for example, a web page, video content, audio content, and so on. In this particular example, the recommended content window 708 includes a recommended advertisement window 710 that may display advertisements that are retrieved based on user behavior data and/or any other suitable user-specific parameter(s). While user interface 702 is illustrated as providing the recommended content in a separate window (e.g., the recommended content window 708), this is intended as an example only. Recommended content may be provided in a variety of contexts and manners, and may be presented such that the recommended content permeates a user's experience on a mobile device. For example, recommended links and advertisements may be provided interspersed with other content on the mobile device.

While certain aspects of user-relevant mobile content techniques have been described in relation to content retrieved by content service 104, it is contemplated that the techniques may be used to retrieve content in a variety of settings. For example, user-relevant mobile content techniques may be implemented to enable a mobile device to retrieve content directly from a content resource, such as a user's associate in a social network, a website, and so on. A variety of other examples are also contemplated.

Conclusion

Although the user-adaptive recommended mobile content techniques have been described in language specific to structural features and/or methodological acts, it is to be understood that the appended claims are not necessarily limited to the specific features or acts described. Rather, the specific features and acts are disclosed as example forms of implementing the theme based content interaction techniques.

What is claimed is:

1. A method comprising:
receiving user behavior data associated with a user's behavior on a mobile device, the user behavior data being automatically detected on the mobile device;
identifying recommended content that correlates to the user behavior data; and
transmitting a notification for receipt by the mobile device, the notification configured to be displayed in a user's homepage on the mobile device and enable the user to access the recommended content using one or more features of the notification.

2. A method as described in claim 1, wherein the user behavior data comprises one or more of:
one or more websites to which the user has navigated;
the content of one or more messages sent by the user; or
search terms provided by the user for conducting a search.

3. A method as recited in claim 1, wherein the notification comprises one or more hyperlinks that are selectable to access one or more instances of the recommended content.

4. A method as recited in claim 1, wherein the notification comprises one or more instances of the recommended content.

5. A method as recited in claim 1, wherein the recommended content comprises an advertisement.

6. A method as recited in claim 1, wherein the recommended content correlates to a particular time-of-day.

7. A method as recited in claim 1, wherein identifying the recommended content comprises identifying recommended content that correlates to a geographic location of the user.

8. A method comprising:
determining a location of a mobile device;
identifying location-relevant recommended content that correlates to both the location of the mobile device and user behavior data associated with a user of the mobile device, the user behavior data describing user interaction with the mobile device; and
transmitting a notification to be received by the mobile device, the notification being configured to enable the user to access the location-relevant recommended content using one or more features of the notification.

9. A method as recited in claim 8, wherein the notification is configured to populate at least part of a homepage on the mobile device.

10. A method as recited in claim 8, wherein the location comprises a geographic location of the mobile device.

11. A method as recited in claim 8, wherein the location-relevant recommended content correlates to a particular time-of-day.

12. A method as described in claim 8, wherein the user behavior data comprises one or more of:
one or more websites that the user navigates to;
the content of one or more emails sent by the user; or
one or more search terms provided by the user for conducting a search.

13. A method as recited in claim 8, wherein the notification comprises a selectable feature that is selectable to access one or more instances of the location-relevant recommended content.

14. A method as recited in claim 8, wherein the notification comprises one or more instances of the location-relevant recommended content.

15. One or more computer-readable media comprising instructions that are executable to:
gather social network data associated with a user of a mobile device, the social network data being based at least in part on the behavior of one or more user associates that communicate with the user via a social network;
identify recommended content that correlates to the social network data; and
transmit a notification for receipt by the mobile device, the notification including one or more aspects that are selectable to access at least some of the recommended content.

16. One or more computer-readable media as recited in claim 15, wherein the notification is configured to be automatically displayed in a homepage on the mobile device.

17. One or more computer-readable media as recited in claim 15, wherein the social network data comprises one or more of:
one or more websites that a user associate navigates to;
the content of one or more emails sent by the user associate to the user of the mobile device; or
one or more search terms provided by the user associate for conducting a search.

18. One or more computer-readable media as recited in claim 15, wherein the recommended content is relevant to a particular time-of-day and includes an activity in which the user may participate with one or more of the user associates that communicate with the user via the social network.

19. One or more computer-readable media as recited in claim 15, wherein the recommended content correlates to a location of the user of the mobile device.

20. One or more computer-readable media as recited in claim 15, wherein the notification comprises one or more instances of the recommended content.
